(19) United States
(12) Patent Application Publication
(10) Pub. No.: US 2021/0241369 A1
(43) Pub. Date: Aug. 5, 2021

(54) SYSTEMS AND METHODS FOR UTILIZING SENSOR-BASED VEHICLE TELEMATICS DATA TO ADJUST A VARIABLE VEHICLE OBLIGATION ARRANGEMENT

(71) Applicant: STATE FARM MUTUAL AUTOMOBILE INSURANCE COMPANY, Bloomington, IL (US)

(72) Inventors: Kristopher Keith Gaudin, Bloomington, IL (US); Justin Davis, Normal, IL (US); Jacob J. Alt, Downs, IL (US); Matthew S. Megyese, Bloomington, IL (US); John Lucas Bothwell, Bloomington, IL (US)

(21) Appl. No.: 15/782,610

(22) Filed: Oct. 12, 2017

Related U.S. Application Data
(60) Provisional application No. 62/544,352, filed on Aug. 11, 2017.
(60) Provisional application No. 62/469,313, filed on Mar. 9, 2017.
(60) Provisional application No. 62/410,221, filed on Oct. 19, 2016.

(51) Int. Cl. G06Q 40/02; G06Q 30/02; G07C 5/00; G07C 5/08

(52) U.S. Cl. CPC G06Q 40/025; G06Q 30/0283; G07C 5/08; B60W 2550/40; G07C 5/008

(57) ABSTRACT

Vehicle usage-based data, including telematics data, may be utilized to generate and/or adjust one or more terms (e.g., a variable interest rate and/or variable principle amount) of a variable vehicle loan. Telematics data may include, for example, data generated via a vehicle mounted and/or mobile electronic device-mounted sensors. The one or more terms may be additionally or alternatively be adjusted based upon transportation metrics associated with usage of the vehicle by a transportation network company (TNC) and/or TNC driver.

### CROSS REFERENCE TO RELATED APPLICATIONS

This application claims priority to and the benefit of the filing date of (1) provisional U.S. Application Ser. No. 62/410,221, filed Oct. 19, 2016 and entitled “Systems and Methods for Utilizing Vehicle Usage-Based Metrics for Generating Automobile Loans,” (2) provisional U.S. Application Ser. No. 62/469,313, filed Mar. 9, 2017 and entitled “Systems and Methods for Utilizing Vehicle Usage-Based Metrics for Generating Automobile Loans,” and (3) provisional U.S. Application Ser. No. 62/544,352, filed Aug. 11, 2017 and entitled “Systems and Methods for Utilizing Vehicle Usage-Based Metrics for Generating Automobile Loans,” the entire disclosures of which are incorporated herein by reference.

### FIELD OF THE INVENTION

The present disclosure generally relates to systems and methods for utilizing vehicle usage-based data or metrics to adjust a vehicle obligation arrangement.

### BACKGROUND

Conventionally, an owner and/or operator of an autonomous vehicle may secure a loan for purchasing the vehicle, and repays the loan in installments over a period of time during ownership and/or operation of the vehicle. A vehicle loan may be offered, for example, by a bank or a financial services company. A vehicle loan may be characterized by a number of terms (e.g., a principal balance or an interest rate of the loan).

To offer a vehicle loan to a borrower, the party offering the loan may consider myriad factors to determine terms of the vehicle loan. For example, it is common for an offering party to consider a ratio of the principal balance of the vehicle loan to a determined value of the vehicle itself (a “loan to value ratio”). Further, the offering party might consider the rate of depreciation of a market value of the vehicle. It is known that the market value of a new vehicle may decrease promptly after purchase. However, market value of a vehicle may also decrease due to an amount or nature of usage, of which the loan offering party may be unaware. Furthermore, an offering party may wish to consider risk factors pertaining to the party receiving the loan or pertaining to the vehicle itself.

Conventionally, however, a loan offering party such as a bank or financial service company may not have access to vehicle usage data from a primary source, if at all. As such, this omission limits the ability of the bank or financial services company to evaluate essential information that may influence the terms of an offered loan.

### SUMMARY

The present embodiments may be related to utilization of vehicle usage-based data, particularly telematics data generated via vehicle sensors and/or mobile device sensors, or metrics to adjust one or more terms of a variable vehicle loan (also referred to herein as a vehicle obligation arrangement). Additionally, the present embodiments may relate to automatically withdrawing payment for the variable vehicle obligation payment, and/or transmitting information regarding the obligation arrangement (e.g., regarding the adjustment thereto) to a mobile device of a party associated with the obligation arrangement. Vehicle telematics data may include, for example, data indicating speed, acceleration, deceleration, braking, cornering, etc. and/or vehicular telemetry metrics originating from a vehicle. Additionally or alternatively, the adjustment to the one or more terms may be based upon (i) other vehicle-specific data such as registration and service/maintenance reports, (ii) underwriting data (also referred to herein as guaranty data) from an underwriting system (also referred to herein as a guaranty system), and/or (iii) transportation metrics from a data storage of a transportation network company (TNC) system.

According to one aspect, a computer-implemented method for utilizing sensor-based vehicle telematics data to adjust a variable vehicle obligation arrangement may be provided. The method may include (1) obtaining, via one or more processors, telematics data indicative of operation of a vehicle, wherein the telematics data includes data generated by one or more vehicle-mounted or mobile device-mounted sensors; (2) adjusting, via the one or more processors, one or more terms of variable vehicle obligation arrangement covering the vehicle, based upon the telematics data; (3) automatically withdrawing, via the one or more processors, a payment for the variable vehicle obligation arrangement from a financial account associated with an owner of the vehicle or associated with the vehicle; and/or (4) transmitting, via the one or more processors, information detailing the adjusted variable vehicle obligation arrangement to a mobile device of the owner of the vehicle. The method may include additional, less, or alternate actions, including those discussed elsewhere herein.

In another aspect, a computer system configured to utilize sensor-based vehicle telematics data to adjust a variable vehicle loan may be provided. The computer system may include (1) a communicative connection to a vehicle data system of a vehicle; (2) one or more processors; and (3) one or more memories storing non-transitory computer-executable instructions that, when executed via the one or more processors, cause the system to: (i) obtain, via one or more processors, telematics data indicative of operation of a vehicle, wherein the telematics data includes data generated by one or more vehicle-mounted or mobile device-mounted sensors, (ii) adjust, via the one or more processors, a variable vehicle loan covering the vehicle, based upon the telematics data, (iii) automatically withdraw, via the one or more processors, a payment for the variable vehicle loan from a financial account associated with an owner of the vehicle or associated with the vehicle, and/or (iv) transmit, via the one or more processors, information detailing the adjusted variable vehicle loan to a mobile device of the owner of the vehicle. The computer system may include additional, less, or alternate functionality and/or components, including those discussed elsewhere herein.

Advantages will become more apparent to those of ordinary skill in the art from the following description of the preferred aspects, which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

FIG. 1 illustrates a diagram of an exemplary computer system 100 for utilizing vehicle usage-based data to generate terms of a vehicle loan;

FIG. 2 illustrates a flow diagram of an exemplary computer-implemented method for utilizing vehicle usage-based data to generate terms of a vehicle loan;

FIG. 3 illustrates a flow diagram of an exemplary computer-implemented method for utilizing vehicle telematics data to adjust a variable vehicle loan;

FIG. 4 illustrates a flow diagram of an exemplary computer-implemented method for utilizing vehicle telematics data to adjust a variable vehicle loan based upon vehicle depreciation; and

FIG. 5 illustrates a flow diagram of an exemplary computer-implemented method for utilizing sensor-based vehicle telematics data to adjust a variable vehicle loan.

The figures depict aspects of the present embodiments for purposes of illustration only. One skilled in the art will readily recognize from the following discussion that alternate aspects of the structures and methods illustrated herein may be employed without departing from the principles of the invention described herein.

### DETAILED DESCRIPTION

Conventionally, in the financial service industry, it is desirable for a party (e.g., a financial services company) offering a loan (e.g., a vehicle loan) to acquire as much relevant information as possible regarding a loan-receiving party (e.g., a vehicle driver) associated with an asset (e.g., a vehicle). Further, the offering party may desire to acquire as much relevant information as possible regarding the asset (e.g., the vehicle) to which the loan pertains before offering the loan. However, in the financial services industry, it may often be difficult for a loan-offering party to determine and/or verify (1) exactly when, where, and how the asset to which the loan pertains is used, (2) the past and present condition of the asset itself, and/or (3) if and how the condition of the asset may change in the future to possibly affect the value of the asset.

The present embodiments address at least these deficiencies in the industry of auto financial services. Using the systems and methods described herein, a loan offering party may obtain valuable information indicative of usage of a vehicle to which the loan (also referred to herein as an obligation arrangement) pertains, or indicative of the usage of another vehicle owned and/or operated by a loan receiving party. For example, a loan-offering party may form a connection with a vehicle data system aboard a vehicle to obtain vehicle usage data (e.g., operations data) from the vehicle data system. As another example, the loan-offering party may form a connection with a transportation network company (TNC) system (e.g., UBER®, Lyft®) to obtain vehicle usage data from the TNC system.

Obtaining vehicle usage data from either or both sources provides relevant information that would allow the loan-offering party to better understand the condition and value of one or more assets, as well as the behaviors and risks involved with a loan-receiving party such as a driver. Thus, a loan-offering party using the systems and methods herein may determine, generate, and offer loans that better reflect the conditions that affect vehicle loans.

Accordingly, the present embodiments improve an existing technological process in the financial services industry. In particular, the present embodiments improve the technological process of data-driven vehicle loan generation by utilizing vehicle usage-based data (e.g., from a vehicle data system, and/or a TNC system) to generate terms of a vehicle loan.

### Utilization of Vehicle Usage Data

A central processing system may generate one or more terms of a vehicle loan based upon obtained vehicle usage data. In some embodiments, vehicle usage data may include vehicle operations data in the form of telematics data and one or more vehicular telemetry metrics (e.g., speed, location, brake usage, engine or malfunction readings, mileage, autonomous vehicle feature or system usage or extent of operation, etc.) and/or other vehicle data (registration or maintenance/service records, etc.) obtained or received from a vehicle data system of a vehicle. A central processing system may obtain the vehicle usage data from a communicative connection from the vehicle data system. Vehicle usage data may be data indicative of operations of a vehicle (referred to herein as “vehicle operations data”). Vehicle operations data may indicate current operation of the vehicle, past operation of the vehicle, or even a future operation and/or condition of the vehicle. The vehicle may be an autonomous or semi-autonomous vehicle is some embodiments.

Additionally, or alternatively, vehicle usage data may include one or more transportation metrics obtained by a Transportation Network Company (TNC) system (e.g., drive history information from an Uber or Lyft data store). The one or more transportation metrics (e.g., a distance driven, a number of trips completed, a time of driving, a payment earned, a driver rating, or an estimated fuel cost) may be stored, for example at a TNC data storage, and a central processing system may obtain this vehicle usage data from a communicative connection with the TNC system. The TNC system may be partially or entirely implemented within a device of a receiving party, such as a TNC driver. Additionally or alternatively, the TNC system may be a proprietary TNC system, at least a part of which may be implemented remotely.

In any case, in addition to vehicle usage data, terms of the vehicle loan may be generated further based upon underwriting (also referred to herein as “guaranty”) data (e.g., data regarding a party receiving the loan, or data generally indicating a type of vehicle, etc.).

The generated terms may be terms of a vehicle loan for which the receiving party is eligible. Once the terms of the loan are generated, the terms may be transmitted to a device (e.g., a desktop, laptop, a smartphone, a PDA, pager, an on-board vehicle computer, smart watch, smart glasses, other wearable electronics, or other mobile device) of the receiving party.

In some embodiments, the vehicle usage data (e.g., vehicle operations data and/or transportation metrics) may be indicative of usage of a vehicle by the receiving party (and/or another one or more parties), and the vehicle loan may correspond to a purchase of that same vehicle by the receiving party. In other embodiments, the vehicle usage data may be indicative of usage of a first vehicle, and the vehicle loan may correspond to a purchase of a second vehicle by the receiving party. In other words, vehicle usage data from one vehicle may be utilized toward generating loans corresponding to a separate vehicle.

In any case, vehicle usage data may include vehicle telematics data accumulated or generated via one or more computing devices removably or fixedly mounted to the vehicle (e.g., a vehicle-mounted device and/or sensor) and/or via one or more other devices or sensors associated with the vehicle (e.g., a smartphone of a driver often located within the vehicle during usage of the vehicle). Vehicle telematics data may include instantaneous telematics data (e.g., telemetry metrics such as speed, cornering, acceleration, braking, location, direction, mileage, etc.) sampled at one or more times or time periods, and/or continuously during usage of the vehicle. Additionally or alternatively, vehicle telematics data may include aggregate data (e.g., miles driven, fuel used, etc.) collected at a beginning and/or end of usage of the vehicle, and/or during usage of the vehicle. In some cases, some vehicle telematics data may be determined or inferred from other vehicle telematics data. For instance, miles driven and/or fuel costs may be determined based upon speed and/or duration of driving. As another example, a number of trips conducted and/or an amount of compensation earned as a TNC driver may be determined based upon speed, duration of driving, fuel usage, miles driven, location data, and/or other vehicle usage data.

In any case, vehicle telematics data may be transmitted, for example, via one or more wired and/or wireless connections to the central processing system or to another system. Additionally or alternatively, vehicle telematics data may be stored at one or more computer storage media on board the vehicle, to be physically retrieved.

In some embodiments, a receiving party may include, for example, an individual purchasing a vehicle for personal use. In these embodiments, vehicle usage data may be indicative of the individual's use of the vehicle or another vehicle, and may be obtained from a vehicle data system of a respective vehicle (e.g., vehicular telemetry metrics), and/or from a TNC system (e.g., income earned by the individual as a TNC driver, distance driven, estimated fuel cost).

In other embodiments, the receiving party may include a company (e.g., a TNC). In these embodiments, the vehicle loan may be sought by the company for a purchase of a vehicle of a fleet of vehicles owned and/or operated by the company. Vehicle usage data may be indicative of usage of one or more vehicles by the company, and may be obtained from one or more vehicle data systems of respective vehicles, or from a company data storage (e.g., a TNC data storage) of a proprietary company system (e.g., a TNC system).

In some embodiments, the vehicle may be an autonomous vehicle or a semiautonomous vehicle (i.e., having some autonomous features or entirely autonomous to operate without a human driver). For example, the vehicle may be a partially or entirely self-driving vehicle. In these embodiments, a receiving party associated with the vehicle may include a party (e.g., an individual or company) that owns the vehicle or otherwise causes the vehicle to operate autonomously. In other words, even if the vehicle is at least partially autonomous such that the vehicle is not operated by a driver physically located within the vehicle, the vehicle may nevertheless be associated with a receiving party such as an individual or a TNC.

In some embodiments, the systems and methods herein may further utilize the vehicle usage data (e.g., telematics data) to generate and/or offer one or more terms of a credit card for the receiving party (and/or another party). Generated terms may include, for example, a monthly spending limit, a term, an interest rate, etc., and may be generated based at least in part upon the vehicle usage data. Generated terms may be transmitted to the receiving party (e.g., via one or more wired or wireless connections with a mobile or other computing device of the receiving party). In some embodiments, a receiving party (e.g., a TNC driver) may “opt in” to a credit card payment program that may directly pull or redirect earnings (e.g., earnings from driving for a TNC) to pay a credit card balance (e.g., on a monthly basis).

In some aspects, a party associated with a vehicle (e.g., an insurance customer) may share their vehicle usage data (e.g., telematics data) and/or other data with an auto insurance provider, such as by “opt in” into an insurance discount program. In return, an auto insurance provider may analyze (e.g., at a remote server) the vehicle usage data and based at least upon the vehicle usage data, estimate and/or provide, to the party, an insurance discount for the party, and/or for a vehicle (e.g., a smart, autonomous, and/or semiautonomous vehicle or another with safety features or systems) associated with the party. An insurance discount may, for example, include a reduced one-time or monthly premium, a temporary or permanently reduced deductible, and/or some other reduced cost or fee. In addition to auto insurance, other types of insurance may be bundled and offered based upon the telematics data, such as accidental death life insurance.

Additionally or alternatively, in some embodiments, the insurance customer may share their vehicle usage data (e.g., telematics data) and/or other data with an auto insurance provider, such as by “opt in” into an insurance quote program. In return, an auto insurance provider may analyze (e.g., at a remote server) the vehicle usage data, and based upon at least the vehicle usage data, provide, to the party, an auto insurance quote or policy adjustment for the party and/or vehicle (e.g., a smart, autonomous, and/or semiautonomous vehicle or another with safety features or systems) associated with the party. The insurance quote may include on or more terms (e.g., a premium, deductible, coverage limit, policy element, etc.) of an insurance policy. In some embodiments, the insurance quote may be a usage-based insurance quote. For example, one or more terms of the insurance quote may be generated based upon risk determined via analysis of vehicle usage data (e.g., distance driven, frequency of driving, routes driven, speed, acceleration, etc.) that may indicate risk associated with a vehicle.

### Exemplary Usage-Based Vehicle Loan Generation System

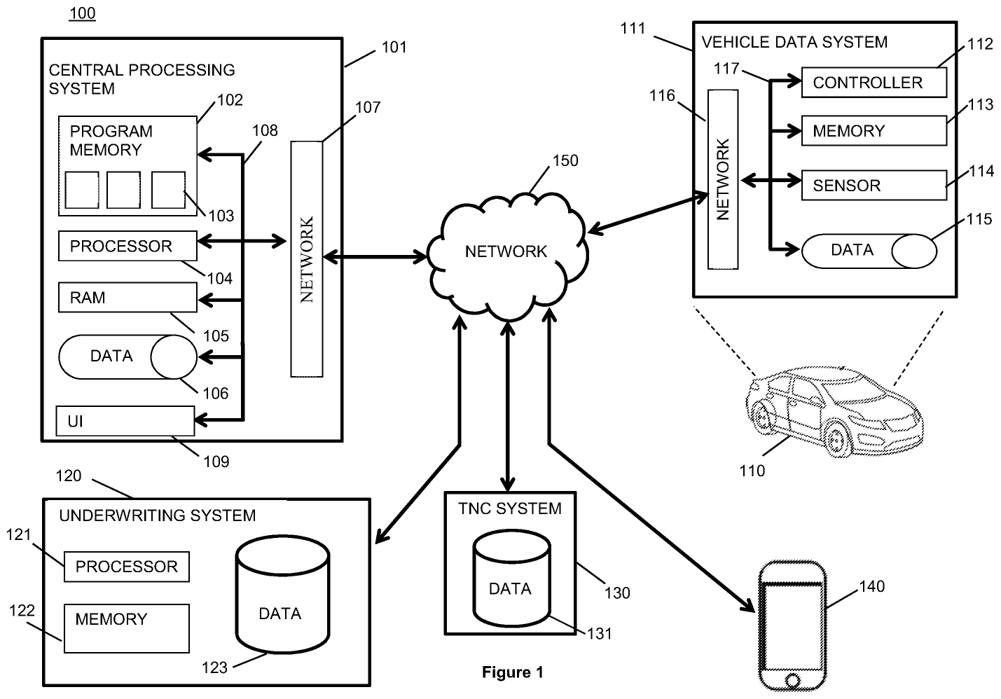

FIG. 1 illustrates a diagram of an exemplary computer system 100 for utilizing vehicle usage-based data to generate terms of a vehicle loan. The high-level architecture may include both hardware and software applications, as well as various data communications channels for communicating data between the various hardware and software components. The system 100 may be roughly divided into a number of subsystems and components. A central processing system 101 may utilize vehicle usage-based data to generate terms of a usage-based vehicle loan for which a receiving party is eligible, the terms of the vehicle loan based upon one or more of: vehicle usage data in the form of vehicular telemetry data or other information received from a vehicle data system 111, underwriting data (also referred to herein as “guaranty data”) received from an underwriting system (also referred to herein as a guaranty system) 120, and vehicle usage data in the form of transportation network company (TNC) data received from a TNC system 130. The terms of the vehicle loan may be transmitted to a device 140 of the receiving party. The above described systems, components, and devices may communicate over a network 150 (e.g., the Internet).

In particular, the central processing system 101 may utilize vehicle usage-based data to generate and transmit terms of a vehicle loan for which a receiving party is eligible. The central processing system 101 may include a program memory 102 such as a read-only memory (ROM), the program memory 102 storing one or more programs 103. Alternatively or additionally, the central processing system 101 may include a random-access memory (RAM) 105. Either or both of the program memory 102 and the RAM 105 may contain or store instructions that, when executed on a processor 104, cause the central processing system 101 to perform functions described herein. The central processing system 101 may further include a data storage 106 (e.g., a memory or a server) that may store data generated by the central processing system 101 and/or data retrieved from other components or subsystems or the system 100. Further, the central processing system 101 may include one or more user interfaces 109. The one or more user interfaces 109 may allow a user and/or operator of the central processing system to operate, maintain, and/or configure the central processing system 101 and/or other components of the system 100.

The components 102-106 of the central processing system 101 may communicate via a bus 108. The bus 108 may communicatively connect the components to a network interface 107. The network interface 107 may be communicatively connected to a network 150, the network 150 communicatively connecting the central processing system 101 to other components and subsystems of the system 100, as illustrated in FIG. 1 and described herein. The central processing system 101 may generate terms of a vehicle loan for which a receiving party is eligible, based upon vehicle usage-based data.

The one or more user interfaces 109 and network interfaces 107 may be wired and/or wireless interfaces. The central processing system 101 may be implemented via one or more servers. Alternatively, the central processing system 101 may be implemented by one or more cloud servers accessible via a web interface or another application, or by some other suitable application.

The network 150 may include one or more wired and/or wireless networks. For example, some components and/or subsystems of the central processing system may be physically connected in a wired network, while other components may be communicatively connected via a wireless network such as a WLAN or the Internet. The network 150 may include one or more private networks or public networks.

In some embodiments, vehicle usage-based data may originate from a vehicle data system 111, at least part of which may be disposed on-board the vehicle 110. In these embodiments, vehicle usage-based data may include one or more vehicular telemetry metrics (e.g., odometer readings, GPS data, engine readings, malfunction readings, fluid level readings, driving patterns, etc.) and/or other vehicle usage information such as registration or service/maintenance records. Additionally, or alternatively, vehicle usage-based data may originate from a TNC system 130. In these embodiments, the vehicle usage-based data may include one or more transportation metrics (e.g., a distance driven, a number of trips completed, an amount of time spent driving, a time of day of driving, an amount of payment earned, an estimated fuel cost). A TNC system 130 may be a proprietary system of the TNC. Additionally or alternatively, at least a portion of the TNC system 130 may be partially or entirely implemented within a device of a TNC user or driver, and the system implemented at the user device may be accessible, for example, via an application on the device of the user or driver. For example, a smartphone of a TNC user and/or driver may include a history of the respective user and/or driver's TNC usage, which may include vehicle usage-based metrics. In any case, the TNC system 130 may include a TNC data storage 131 including the vehicle usage data.

The vehicle data system 111 may be a data system disposed on-board a vehicle 110. Alternatively, some or all components of the vehicle data system 111 may be disposed remotely from the vehicle 110. In any case, the vehicle data system 111 may include a controller 112. The controller, which may include a microprocessor, may be configured to execute instructions stored on a memory 113. Further, the controller may be configured to monitor the operation of the vehicle 110 by retrieving vehicle usage data such as vehicle operations data in the form of sensor data (i.e. vehicular telemetry metrics) from one or more sensors 114 on-board the vehicle 110. The one or more sensors 114 may be installed within the vehicle 110 to collect one or more vehicular telemetry metrics (e.g., odometer readings, GPS data, engine readings, malfunction readings, fluid level readings, driving habits, etc.) indicative of usage of the vehicle 110. A data storage 115 may store one or more vehicular telemetry metrics obtained by one or more sensors 114. Further, the data storage 115 may store other vehicle usage data such as registration information and service or maintenance records. The components 112-115 may be communicatively connected via a bus 117, the bus 117 may communicatively connect the components 112-115 to a network interface 116, and the network interface 116 may communicatively connect the vehicle data system 111 to the network 150. In some embodiments, the vehicle data system 111 may be configured to automatically transmit at least some vehicle usage data, to the central processing system 101, for example.

The central processing system 101, network 150, vehicle data system 111, vehicle 110, mobile device 140, TNC system 130, underwriting system 120, and/or other computing devices may be interconnected and communicate among themselves via wireless communication or data transmission sent over one or more radio frequency links or wireless communication channels.

As discussed above, vehicle usage data may include vehicle operations data in the form of the one or more vehicular telemetry metrics that are collected at multiple times over the course of ownership and/or operation of the vehicle 110. Multiple options exist for storage and transmission of vehicular telemetry metrics. In some embodiments, one or more vehicular telemetry metrics may be communicated directly to the central processing system 101 upon retrieval from one or more sensors 114. In these embodiments, the one or more vehicular telemetry metrics may be stored by the central processing system 101 at the data storage 106. In other embodiments, the one or more vehicular telemetry metrics may be stored, alternatively or additionally, by the vehicle data system 111 at the data storage 115. In these embodiments, the central processing system 101 may request and receive one or more vehicular telemetry metrics from the data storage 115 of the vehicle data system 111. In any case, the central processing system may obtain the vehicle operations data, including one or more vehicular telemetry metrics and may generate terms of a vehicle loan for which the receiving party is eligible, based upon at least one or more vehicle operations data. The vehicle loan may correspond to a purchase, by the receiving party, of the vehicle to which the vehicle operations data pertains. Alternatively, the vehicle loan may correspond to a purchase of a separate vehicle by the receiving party.

The central processing system 101 may further be communicatively connected to an underwriting system 120, such as via wired or wireless communication or data transmission over one or more radio links or digital communication channels. The underwriting system may include a processor 121 that executes instructions stored on a memory 122 to perform the functions of the underwriting system 120 described herein. The underwriting system may further include a data storage 123, such as a memory or a server, storing underwriting data corresponding to the receiving party (e.g., a loan history, a purchase history, a driving history, and/or a risk profile of the receiving party). Further, the underwriting system 120 may receive via, via the network 150, vehicle usage data (e.g., operations data) and/or other data corresponding to the receiving party from the vehicle data system 111 and/or the central processing system 101. The underwriting system may store the vehicle usage data at the data storage 123. Even further, the underwriting system 120 may generate underwriting data based upon at least the vehicle usage data.

In some embodiments, the underwriting system 120 may be connected to the central processing system 101 via a communicative connection over a network 150 and the network interface 107, and the central processing system 101 may obtain or receive underwriting data from the underwriting system 120 (such as via wired or wireless communication over one or more radio links or communication channels).

As noted, the connection may include one or more wired or wireless connections over one or more public or private networks. In other embodiments, however, the underwriting system may be integrated within the central processing system 101. In these embodiments, the central processing system 101 and the underwriting system 120 may share one or more memories, processors, data storages, network interfaces, and/or communicative connections, etc. Thus, the central processing system 101 and the underwriting system 120 may share one or more of the functions respectively described regarding those systems herein.

In any case, the central processing system 101 may obtain the underwriting data and generate, based upon the underwriting data, terms of a vehicle loan for which the receiving party is eligible. The vehicle loan may correspond to a purchase, by the receiving party, of the vehicle to which the underwriting data and/or vehicle usage data pertains. Alternatively, the vehicle loan may correspond to a purchase of a separate vehicle by the receiving party.

The central processing system 101 may further be communicatively connected to a transportation network company (TNC) system 130, including a TNC data storage 131. The communicative connection may be established, for example, via the one or more network interfaces 107, which may be one or more wired and/or wireless interfaces (and/or radio links) allowing for wired and/or wireless communications over a public or private network 150. The TNC data storage 131 may be a remote data storage (e.g., a server or a cloud-based server accessible via a web application or a mobile application of a mobile device). Alternatively, or additionally, the TNC 131 may include a local data storage disposed on a device (such as, but not limited to, the device 140) of the receiving party.

Conventionally, a TNC, such as Uber or Lyft, may allow an operator of a vehicle (such as the vehicle 110) to operate the vehicle to provide transportation services. A transportation network company may manage the services performed by an operator of a vehicle, as well as payments from parties receiving the services to the operator of the vehicle. Thus, a TNC data storage 131 may store one or more types of telematics data and/or transportation metrics (e.g., miles driven, fuel usage and/or costs, total services rendered, amount of payment received or income earned, driver “rating” by customers, autonomous feature usage, speed, braking, corning, acceleration, etc.) that may affect terms of a loan or eligibility of the receiving party for a vehicle loan. The TNC system 130 including the TNC data storage 131 may be accessed via a web interface or an application, such as an application on a mobile device of a user.

The central processing system 101 may establish, via the network interface 107 and the network 150, a communicative connection with the TNC system 130, to receive or obtain vehicle usage data in the form of one or more transportation metrics from the TNC system 130. The connection between the central processing system 101 and the TNC system may include one or more wired or wireless connections over one or more public or private networks (and/or radio links or communication channels). In some embodiments, one or more transportation metrics may be communicated directly to the central processing system automatically (e.g., a TNC system 130 automatically transmits TNC data upon completion of a “ride” or transportation session). In other embodiments, the one or more transportation metrics may be stored at the TNC data storage 131, and the central processing system 101 may receive or obtain one or more transportation metrics upon request by the central processing system 101. Still in other embodiments, a user of the TNC system 131 (e.g., a passenger or a driver) may elect to transmit transportation metrics to the central processing system 101, for example, via an interaction with a mobile TNC application executing on the user device 140 or on another device.

In any case, the central processing system 101 may receive or obtain the vehicle usage data and generate, based upon the transportation metrics, one or more terms of a vehicle loan for which the receiving party is eligible. The vehicle loan may correspond to a purchase of the vehicle to which the TNC transportation metrics pertain. Alternatively, the vehicle loan may correspond to a purchase of a vehicle separate from the vehicle to which the transportation metrics pertain.

Further, the central processing system 101 may transmit, to a device 140 of the receiving party via, terms of the vehicle loan for which the receiving party is eligible. The device 140 may be, for example, a smartphone, a desktop or laptop computer, a PDA, and/or a computer disposed within a vehicle of the receiving party. The terms of the loan may be transmitted via the network interface 107 of the central processing system 101 and the network 150, to which the device 140 may be communicatively connected. The communicative connection between the central processing system 101 and the device 140 over the network 150 may include one or more wired or wireless connections over one or more public or private networks, for example. Transmission of the terms of the vehicle loan to the device 140 may prompt the device 140 to display a notification (e.g., a voice notification, a push notification, or an email message) of the receiving party's eligibility for the vehicle loan. The notification may be displayed immediately on the device 140 (e.g., as a push notification, or directing a browser of the device 140 to a web page), or may be stored at the device 140 and activated in response to an action by the user 140 (e.g., launching an application, navigating to a web site, connecting to a network, etc.).

Additionally, or alternatively, the system 100 may be used to generate and transmit terms of a credit card (e.g., a variable-rate credit card) for which the receiving party may be eligible. For example, the central processing system 101 may generate, based upon vehicle usage data (e.g., vehicular operations data or other information from the vehicle data system 111, and/or transportation metrics from the TNC system 130), terms of a credit card for which the receiving party is eligible (e.g., credit limit, balance transfer amounts, APR (annual percentage rate), etc.). Alternatively, or additionally, the terms of the credit card may be generated based upon the underwriting data. In any case, subsequently, the central processing system 101 may transmit, via the network interface 107 and/or the network 150, the generated terms of the credit card to a device 140 of the receiving party. Transmission of the terms of the credit card to the device 140 may prompt the device 140 to display a notification (e.g., a voice notification, a push notification, or an email message) of the receiving party's eligibility for the credit card. The notification may be displayed immediately on the device 140 (e.g., as a push notification, or directing a browser of the device 140 to a web page), or may be stored at the device 140 and activated in response to an action by the user 140 (e.g., launching an application, navigating to a web site, connecting to a network or communication channel, etc.).

### Exemplary Method for Usage-Based Vehicle Loan Generation

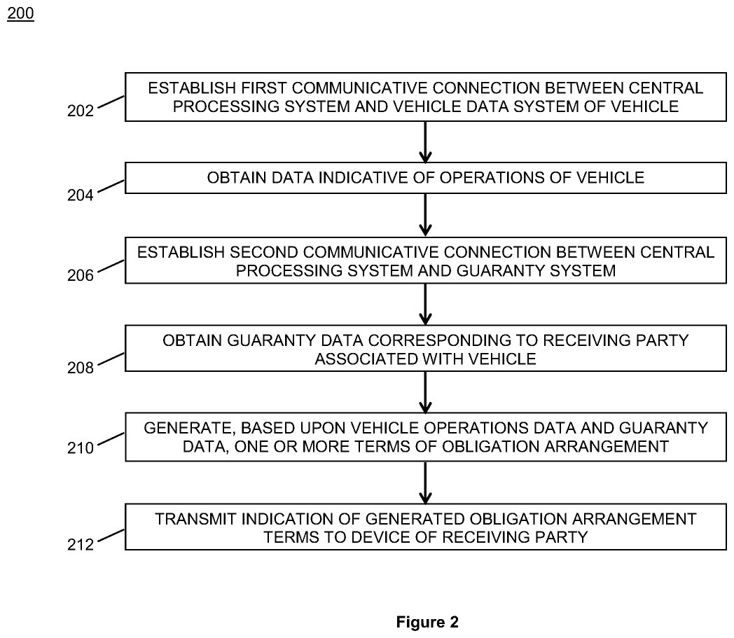

FIG. 2 illustrates a flow diagram of an exemplary computer-implemented method 200 for utilizing vehicle operations data (and/or other usage data) to generate one or more terms of a vehicle loan (also referred to herein as a vehicle obligation arrangement). The method 200 may be implemented by the system 100 depicted in FIG. 1, for example, or by another suitable system. In some embodiments, the method 200 may be initiated by the central processing system 101. In other embodiments, the method 200 may be initiated by the underwriting system 120, e.g., by the underwriting system 120 sending a signal to the central processing system 101 via the network 150, thereby causing the central processing system 101 to initiate actions of the method 200.

In some embodiments, the method 200 may be initiated by the vehicle data system 111. For example, a vehicle data system 111 aboard a vehicle 110 may include a controller 112 configured to send a signal, to the central processing system 101 via the network 150, upon detection of a sensed driving condition, behavior, or vehicle condition, and the received signal may cause the central processing system 101 to initiate actions of the method 200. In some embodiments, a receiving party may initiate the method 200 via a mobile, wearable, or other device 140 of the receiving party. For example, a receiving party may use the device 140 to send, to the central processing system 101 via the network 150, a message or signal indicating a desire of the receiving party to receive terms of a loan for which the receiving party is eligible, and the received signal may cause the central processing system 101 to initiate actions of the method 200.

In any case, the method 200 may include establishing a first communicative connection (such as over one or more radio links or communication channels) between a central processing system and another system (202). The other system may be, for example, a vehicle data system of a vehicle. Additionally or alternatively, the other system may be a system associated with a transportation network company (TNC) and/or TNC driver, and the TNC may be configured to provide data associated with the vehicle used as a TNC vehicle. In some embodiments, a pair of communicative connections may be established, between the central processing system and each of the vehicle data system and the TNC system.

The method 200 may further include obtaining or receiving, at the central processing system, data indicative of operations of the vehicle, the vehicle operations data obtained via the first communicative connection from the other system (204).

Data indicative of operations of the vehicle may include, for example, data indicative of an odometer reading, a positioning reading (e.g., GPS), an engine reading, a malfunction reading, a fluid level reading, a driving behavior and/or behavior pattern, cornering, braking, speed, acceleration, etc. The data may include an indication of distance (e.g., miles) traveled by the vehicle, a number of trips traveled by the vehicle, and/or an estimated or actual amount of fuel used by the vehicle the data may include. Additionally or alternatively to vehicular operations data, the central processing system may obtain, from the vehicle data system, other vehicle usage data such as registration information or service/maintenance records.

In some embodiments, data indicative of operations of the vehicle may include an indication of distance (e.g., miles) traveled by a TNC driver using the vehicle, a number of trips conducted by a TNC driver using the vehicle, an amount of money earned by a TNC driver using the vehicle, and/or an actual or estimated amount of fuel used by the vehicle for TNC driving.

The method 200 may further include establishing, via the one or more network interfaces (and/or radio links or communication channels), a second communicative connection between the central processing system and an underwriting system (also referred to herein as a guaranty system) (206).

The method 200 may further include obtaining or receiving, at the central processing system, underwriting data (also referred to herein as guaranty data) corresponding to a receiving party, the underwriting data obtained via the second communicative connection from the underwriting system (208). In some embodiments, the underwriting data (e.g., a risk value of the receiving party or a vehicle) may include data generated by the underwriting system. In some embodiments, the underwriting system may communicate with a vehicle data system via a wired and/or wireless connection over a public or private network (and/or one or more radio links or communication channels) to receive data indicative of operations of the vehicle, from which the underwriting system may generate underwriting data.

The underwriting system may be configured to automatically transmit underwriting data to the central processing system upon generation, once the connection has been established. Alternatively, the underwriting system may be configured to transmit data upon request by the central processing system or a user thereof. In any case, the underwriting data may correspond to the receiving party and/or a vehicle of the receiving party.

The method 200 may further include generating, at the central processing system and based at least in part upon the vehicle operations data and/or the underwriting data, one or more terms (e.g., interest rate, principal amount, etc.) of a vehicle loan for which the receiving party is eligible (210). In some embodiments, the vehicle loan may correspond to a purchase of the vehicle by the receiving party. In other words, the vehicle to which the loan pertains may be the same vehicle from which the vehicle operations data was received. In other embodiments, however, the vehicle loan may correspond to a purchase of another vehicle by the receiving party. For example, the central processing system may generate one or more terms of a vehicle loan for another vehicle based upon the receiving party's use of the first vehicle. The one or more terms may be generated further based upon other data associated with the vehicle (e.g., registration and/or maintenance data).

In any case, the method 200 may further include transmitting, via the one or more network interfaces, an indication of the generated one or more loan terms to a device of the receiving party (212). The device may be, for example, a laptop or desktop computer, a smartphone, a PDA, and/or an on-board computer aboard a vehicle. The generated one or more terms of the vehicle loan may be transmitted, for example, in the form of a push notification, a pop-up window, or an email message.

Further, in some embodiments, the method 200 may further include (1) establishing, via the one or more network interfaces, a third communicative connection between the central processing system and a transportation network company (TNC) system associated with the receiving party, and (2) obtaining or receiving, at the central processing system, one or transportation metrics indicative of at least one of transportation provided by using the vehicle or transportation provided by the receiving party, the one or more transportation metrics obtained via the third communicative connection from the transportation network company system. In these embodiments, the one or more terms of the vehicle loan may be generated further based upon the one or more transportation metrics. The one or more transportation metrics may include, for example, a distance (e.g., miles) driven or otherwise traveled, a number of trips completed, an amount of time spent driving, a time of day of driving, an amount of payment received or income earned by a driver/operator, and/or an estimated fuel usage and/or cost. The communicative connection between the central processing system and the TNC system may be one or more wired or wireless connections via one or more public or private networks.

Further, in some embodiments the method 200 may further include (1) generating, at the central processing system and based at least in part upon the vehicle operations data and/or the underwriting data, one or more terms of a credit card (e.g., a variable rate credit card) for which the receiving party is eligible, and (2) transmitting, by the central processing system to the device of the receiving party, an indication of the generated one or more terms of the credit card. The one or more terms of the credit card may include, for example, a variable limit and/or interest rate.

In some embodiments, the method 200 may further include adjusting a usage-based insurance rate for the vehicle and/or for a driver of the vehicle. A usage-based insurance rate may include an insurance-related cost such as a deductible, premium, etc., and the adjustment thereto may be based at least in part upon the data indicative of operations of the vehicle.

In some embodiments, the order of elements of computer-implemented method 200 may be altered. For example, in some embodiments, the central processing system may establish a connection with and receive underwriting data from the underwriting system before establishment of a connection with the vehicle data system. Furthermore, the method 200 may include additional, alternate, or fewer actions, including those described in this detailed description. The method 200 may be accomplished via a computer system having one or more local or remote processors, servers, sensors, and/or transceivers configured to perform the functionality discussed herein, and/or non-transitory computer-readable media or medium having stored thereon computer or processor executable instructions for directing the functionality discussed herein.

### Exemplary Method for Adjusting a Variable Vehicle Loan

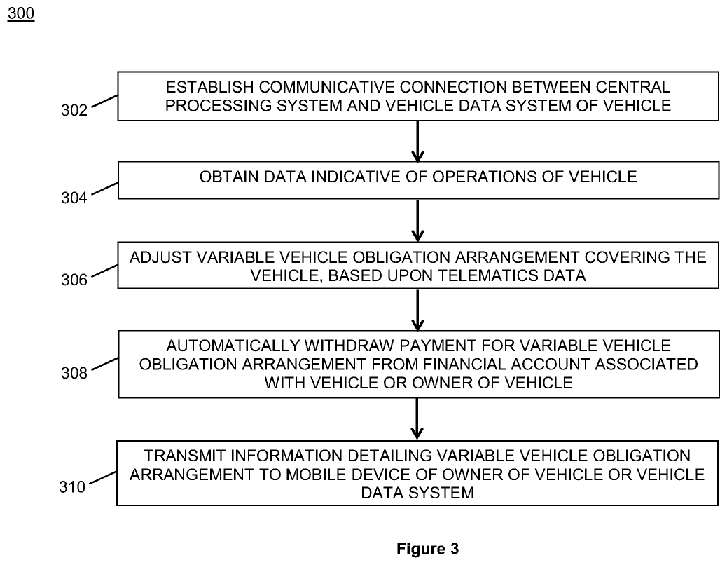

FIG. 3 illustrates a flow diagram of an exemplary computer-implemented method 300 for utilizing vehicle telematics data to adjust a variable vehicle loan. The method 300 may be implemented by the system 100 depicted in FIG. 1, for example, or by another suitable system. In some embodiments, the method 300 may be initiated by the central processing system 101. In other embodiments, the method 300 may be initiated by the underwriting system 120, e.g., by the underwriting system 120 sending a signal to the central processing system 101 via the network 150, thereby causing the central processing system 101 to initiate actions of the method 300.

In some embodiments, the method 300 may be initiated by the vehicle data system 111. For example, a vehicle data system 111 aboard a vehicle 110 may include a controller 112 configured to send a signal, to the central processing system 101 via the network 150, upon detection of a sensed driving condition, behavior, or vehicle condition, and the received signal may cause the central processing system 101 to initiate actions of the method 300. In some embodiments, a driver or other party associated with the vehicle 110 may initiate the method 300 via a mobile, wearable, or other device 140 of driver or other party.

The method 300 may include establishing, via one or more network interfaces, a communicative connection (e.g., over one or more radio links or communication channels) between a central processing system and a vehicle data system of a vehicle (302).

The method 300 may further include obtaining (or otherwise receiving) data indicative of operations of the vehicle, wherein the telematics data is obtained or otherwise received via the communicative connection from the vehicle data system (304).

Telematics data indicative of operation of a vehicle may include, for example, data indicative of an odometer reading, positioning (e.g., GPS) readings, an engine reading, a malfunction reading, a fluid level reading, a driving behavior or pattern, cornering, braking, speed, acceleration, etc. Additionally or alternatively, telematics data may include an indication of distance (e.g., miles) traveled by the vehicle, a number of trips traveled by the vehicle, and/or an estimated or actual amount of fuel used by the vehicle.

In some embodiments, the vehicle may be a vehicle used by a transportation network company (TNC) and/or TNC driver. In these embodiments, telematics data may include an indication of distance (e.g., miles) traveled by a TNC driver using the vehicle, a number of trips conducted by a TNC driver using the vehicle, an amount of money earned by a TNC driver using the vehicle, and/or an actual or estimated amount of fuel used by the vehicle for TNC driving.

The method 300 may further include adjusting a variable vehicle loan covering the vehicle based at least in part upon the telematics data (306). Adjusting a variable vehicle loan may include altering one or more variable terms (e.g., interest rate and/or principal payment) of the loan, based at least upon obtained telematics data, including any telematics data described in this detailed description. Further, in some embodiments, the adjustment to the variable vehicle loan may be based at least in part upon an estimated depreciation of value of the vehicle. In some embodiments, adjusting a variable vehicle loan may additionally or alternatively adjusting one or more terms of a loan covering another vehicle (e.g., a vehicle separate from that which telematics data is obtained, wherein the vehicle is associated with a same individual, company, etc.).

The method 300 may further include automatically withdrawing a payment (e.g., a one-time payment, a recurring monthly or yearly payment, etc.) for the variable vehicle loan from a financial account (e.g., checking account) associated with an owner of the vehicle, or from a financial account otherwise associated with the vehicle (308). Authorization of automatic withdrawal of payment may be enabled upon an affirmative “opt-in” by a party (e.g., a driver) associated with the financial account and/or the vehicle.

The method 300 may further include transmitting, via the one or more network interfaces, information detailing the variable vehicle loan to a mobile device (e.g., smartphone, wearable device, vehicle-mounted device, etc.) of the owner of the vehicle and/or owner of the vehicle data system (310). Information detailing the variable vehicle loan may include, for example, an indication of one or more terms of the vehicle loan, such as a term to which an adjustment has been made based upon obtained telematics data. The information detailing the variable vehicle loan may be transmitted as text message, phone call, email message, push notification, and/or another suitable form.

In some embodiments, the method 300 may further include adjusting a usage-based insurance rate for the vehicle and/or for a driver of the vehicle. A usage-based insurance rate may include an insurance-related cost such as a deductible, premium, etc., and the adjustment thereto may be based at least in part upon the obtained telematics data described herein.

In some embodiments, the method 300 may further include generating one or more terms (e.g., credit limit, interest rate, etc.) of a credit card for which a party (e.g., individual, company, etc.) associated with the vehicle is eligible, based at least in part upon the telematics data. In these embodiments, the method 300 may further include transmitting, to a mobile device associated with the party, an indication of the one or more generated terms.

The computer-implemented method 300 may include additional, fewer, or alternate actions, including those described in this detailed description. The method 300 may be accomplished via a computer system having one or more local or remote processors, servers, sensors, and/or transceivers configured to perform the functionality discussed herein, and/or non-transitory computer-readable media or medium having stored thereon computer or processor executable instructions for directing the functionality discussed herein.

### Exemplary Method for Adjusting a Variable Vehicle Loan Based Upon Vehicle Depreciation

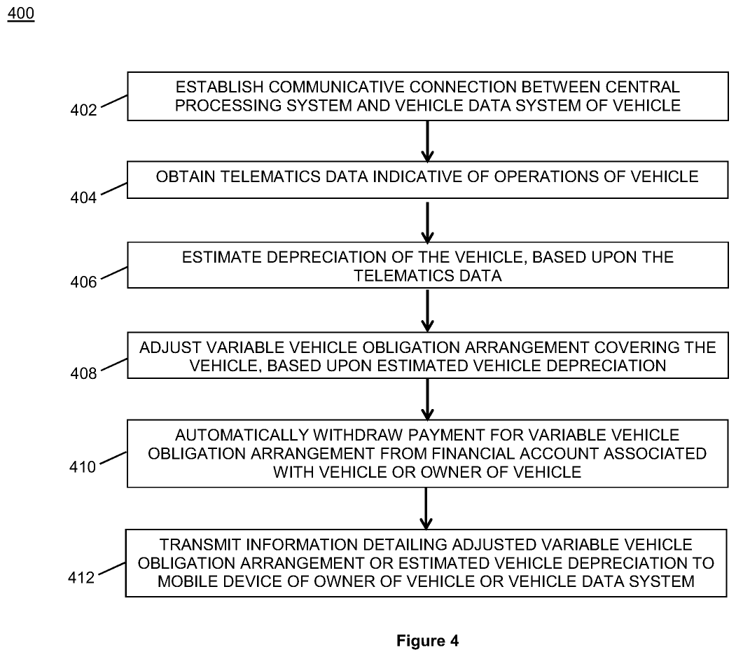

FIG. 4 illustrates a flow diagram of an exemplary computer-implemented method 400 for utilizing vehicle telematics data to adjust a variable vehicle loan. The method 400 may be implemented by the system 100 depicted in FIG. 1, for example, or by another suitable system. In some embodiments, the method 400 may be initiated by the central processing system 101. In other embodiments, the method 400 may be initiated by the underwriting system 120, e.g., by the underwriting system 120 sending a signal to the central processing system 101 via the network 150, thereby causing the central processing system 101 to initiate actions of the method 400.

In some embodiments, the method 400 may be initiated by the vehicle data system 111. For example, a vehicle data system 111 aboard a vehicle 110 may include a controller 112 configured to send a signal, to the central processing system 101 via the network 150, upon detection of a sensed driving condition, behavior, or vehicle condition, and the received signal may cause the central processing system 101 to initiate actions of the method 400. In some embodiments, a driver or other party associated with the vehicle may initiate the method 400 via a mobile, wearable, or other device 140 of the driver or other party.

The method 400 may include establishing, via one or more network interfaces, a communicative connection (e.g., over one or more radio links or communication channels) between a central processing system and a vehicle data system of a vehicle (402).

The method 400 may further include obtaining (or otherwise receiving), at the central processing system, telematics data indicative of operations of the vehicle, wherein the telematics data is obtained via the communicative connection from the vehicle data system (404).

Telematics data indicative of operation of a vehicle may include, for example, data indicative of an odometer reading, positioning (e.g., GPS) readings, an engine reading, a malfunction reading, a fluid level reading, a driving behavior or pattern, cornering, braking, speed, acceleration, etc. Additionally or alternatively, telematics data may include an indication of distance (e.g., miles) traveled by the vehicle, a number of trips traveled by the vehicle, and/or an estimated or actual amount of fuel used by the vehicle.

In some embodiments, the vehicle may be a vehicle used by a transportation network company (TNC) and/or TNC driver. In these embodiments, telematics data may include an indication of distance (e.g., miles) traveled by a TNC driver using the vehicle, a number of trips conducted by a TNC driver using the vehicle, an amount of money earned by a TNC driver using the vehicle, and/or an actual or estimated amount of fuel used by the vehicle for TNC driving.

The method 400 may further include estimating a depreciation of the vehicle, based at least in part upon the telematics data (406). Depreciation may be estimated, for example, based upon damage, natural wear, etc., as indicated by telematics data.

The method 400 may further include adjusting a variable vehicle loan covering the vehicle, based at least in part upon the estimated vehicle depreciation (408). Adjusting a variable vehicle loan may include altering one or more variable terms (e.g., interest rate and/or principal payment) of the loan, based upon the estimated depreciation, alone or in combination with other factors, including telematics data described in this detailed description. In some embodiments, adjusting a variable vehicle loan may additionally or alternatively adjusting one or more terms of a loan covering another vehicle (e.g., a vehicle separate from that which telematics data is obtained, wherein the vehicle is associated with a same individual, company, etc.).

The method 400 may further include automatically withdrawing a payment (e.g., a one-time payment, a recurring monthly or yearly payment, etc.) for the variable vehicle loan from a financial account (e.g., checking account) associated with an owner of the vehicle, or from a financial account otherwise associated with the vehicle (410). Authorization of automatic withdrawal of payment may be enabled upon an affirmative “opt-in” by a party (e.g., a driver) associated with the financial account and/or the vehicle.

The method 400 may further include transmitting, via the one or more network interfaces, information detailing the adjusted variable vehicle loan and/or the estimated vehicle depreciation to a mobile device (e.g., smartphone, wearable device, vehicle-mounted device, etc.) of the owner of the vehicle or the vehicle data system (412). Information detailing the variable vehicle loan may include, for example, an indication one or more terms of the vehicle loan, such as a term to which an adjustment has been made based upon obtained telematics data. The information may further include particular an indication of particular telematics data upon which the adjustment and/or the estimation of vehicle depreciation is based. The information detailing the variable vehicle loan and/or depreciation may be transmitted as text message, phone call, email message, push notification, and/or another suitable form.

In some embodiments, the method 400 may further include adjusting a usage-based insurance rate for the vehicle and/or for a driver of the vehicle. A usage-based insurance rate may include an insurance-related cost such as a deductible, premium, etc., and the adjustment thereto may be based at least in part upon the estimated vehicle depreciation and/or the obtained telematics data described herein.

In some embodiments, the method 400 may further include generating one or more terms (e.g., credit limit, interest rate, etc.) of a credit card for which a party (e.g., individual, company, etc.) associated with the vehicle is eligible, based at least in part upon the estimated vehicle depreciation and/or the telematics data. In these embodiments, the method 300 may further include transmitting, to a mobile device associated with the party, an indication of the one or more generated terms.

The computer-implemented method 400 may include additional, fewer, or alternate actions, including those described in this detailed description. The method 400 may be accomplished via a computer system having one or more local or remote processors, servers, sensors, and/or transceivers configured to perform the functionality discussed herein, and/or non-transitory computer-readable media or medium having stored thereon computer or processor executable instructions for directing the functionality discussed herein.

### Exemplary Method for Utilizing Telematics Data Generated Via Sensors

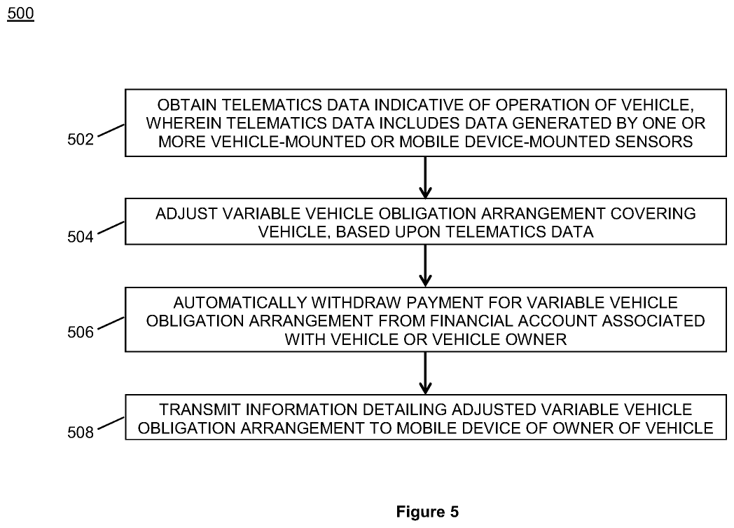

FIG. 5 illustrates a flow diagram of an exemplary computer-implemented method 500 for utilizing sensor-based vehicle telematics data to adjust a variable vehicle loan. The method 500 may be implemented by the system 100 depicted in FIG. 1, for example, or by another suitable system. In some embodiments, the method 500 may be initiated by the central processing system 101. In other embodiments, the method 500 may be initiated by the underwriting system 120, e.g., by the underwriting system 120 sending a signal to the central processing system 101 via the network 150, thereby causing the central processing system 101 to initiate actions of the method 500.

In some embodiments, the method 500 may be initiated by the vehicle data system 111. For example, a vehicle data system 111 aboard a vehicle 110 may include a controller 112 configured to send a signal, to the central processing system 101 via the network 150, upon detection of a sensed driving condition, behavior, or vehicle condition, and the received signal may cause the central processing system 101 to initiate actions of the method 500. In some embodiments, a driver or other party associated with the vehicle may initiate the method 500 via a mobile, wearable, or other device 140 of the driver or other party.

The method 500 may include obtaining, via one or more processors, telematics data indicative of operation of a vehicle, wherein the telematics data includes data generated by one or more vehicle-mounted and/or one or more mobile device-mounted sensors (502). In some embodiments, the method 500 may include, prior to obtaining the data, establishing a communicative connection (e.g., via one or more radio links and/or communication channels) between a system configured to obtain the telematics data (e.g., a central processing system) and a vehicle data system and/or mobile device configured to generate or otherwise receive telematics data via one or more sensors.

Telematics data indicative of operation of a vehicle may include, for example, data indicative of an odometer reading, positioning (e.g., GPS) readings, an engine reading, a malfunction reading, a fluid level reading, a driving behavior or pattern, speed, acceleration, cornering, braking, etc. Additionally or alternatively, telematics data may include an indication of distance (e.g., miles) traveled by the vehicle, a number of trips traveled by the vehicle, and/or an estimated or actual amount of fuel used by the vehicle.

In some embodiments, the vehicle may be a vehicle used by a transportation network company (TNC) and/or TNC driver. In these embodiments, telematics data may include an indication of distance (e.g., miles) traveled by a TNC driver using the vehicle, a number of trips conducted by a TNC driver using the vehicle, an amount of money earned by a TNC driver using the vehicle, and/or an actual or estimated amount of fuel used by the vehicle for TNC driving.

The method 500 may further include adjusting, via the one or more processors, a variable vehicle loan covering the vehicle, based upon the telematics data (504). Adjusting a variable vehicle loan may include altering one or more variable terms (e.g., interest rate and/or principal payment) of the loan, based at least upon obtained telematics data, including any telematics data described in this detailed description. Further, in some embodiments, the adjustment to the variable vehicle loan may be based at least in part upon an estimated depreciation of value of the vehicle. In some embodiments, adjusting a variable vehicle loan may additionally or alternatively adjusting one or more terms of a loan covering another vehicle (e.g., a vehicle separate from that which telematics data is obtained, wherein the vehicle is associated with a same individual, company, etc.).

The method 500 may further include automatically withdrawing a payment (e.g., a one-time payment, a recurring monthly or yearly payment, etc.) for the variable vehicle loan from a financial account (e.g., checking account) associated with an owner of the vehicle, or from a financial account otherwise associated with the vehicle (506). The ability of a system to automatically withdraw payment may be enabled, for example, upon “opt-in” authorization by a party associated with the financial account and/or the vehicle.

The method 500 may further include transmitting information detailing the adjusted variable vehicle loan to a mobile device of the owner of the vehicle. Information detailing the variable vehicle loan may include, for example, an indication of one or more terms of the vehicle loan, such as a term to which an adjustment has been made based upon obtained telematics data. The information detailing the variable vehicle loan may be transmitted as text message, phone call, email message, push notification, and/or another suitable form.

In some embodiments, the method 500 may further include adjusting a usage-based insurance rate for the vehicle and/or for a driver of the vehicle. A usage-based insurance rate may include an insurance-related cost such as a deductible, premium, etc., and the adjustment thereto may be based at least in part upon the obtained telematics data described herein.

In some embodiments, the method 500 may further include generating one or more terms (e.g., credit limit, interest rate, etc.) of a credit card for which a party (e.g., individual, company, etc.) associated with the vehicle is eligible, based at least in part upon the telematics data. In these embodiments, the method 500 may further include transmitting, to a mobile device associated with the party, an indication of the one or more generated terms.

The computer-implemented method 500 may include additional, fewer, or alternate actions, including those described in this detailed description. The method 500 may be accomplished via a computer system having one or more local or remote processors, servers, sensors, and/or transceivers configured to perform the functionality discussed herein, and/or non-transitory computer-readable media or medium having stored thereon computer or processor executable instructions for directing the functionality discussed herein.

### Other Exemplary Embodiments

In some aspects, one or more terms of a variable vehicle loan may be generated and/or adjusted based upon the vehicle telematics data. For instance, vehicle depreciation may be estimated or updated based upon vehicle telematics data indicative of vehicle usage and/or vehicle maintenance. A variable vehicle loan interest rate and/or variable vehicle loan monthly principle amount payment may be estimated to be inversely proportional or inversely related to the vehicle depreciation. For instance, with less vehicle usage, the loan term may be extended, and/or with more vehicle usage, the loan term may be shortened. Vehicle usage may be based upon miles driven (e.g., a threshold mileage such as five thousand or ten thousand miles per year) and/or fuel used, or on more general vehicle usage, including an amount and/or type of autonomous vehicle feature, system, or software usage. Further, one or more terms of a vehicle loan or variable vehicle loan may be generated and/or adjusted based upon TNC driving data indicative of TNC driving by a party receiving the loan. For example, terms may be adjusted based upon stability of TNC earnings, volume of TNC earnings, locations where TNC earnings are earned, etc.

In one aspect, a computer-implemented method of collecting and analyzing telematics data may be provided. The method may include (1) establishing, via one or more network interfaces, a first communicative connection between a central processing system and a vehicle data system via wireless communication or data transmission over one or more radio links or communication channels; (2) obtaining or receiving, at the central processing system, telematics data indicative of operations of the vehicle via wireless communication or data transmission over one or more radio links or communication channels, wherein the telematics data includes an indication of miles driven or traveled by the vehicle and is obtained via the first communicative connection from the vehicle data system; (3) establishing, via the one or more network interfaces, a second communicative connection between the central processing system and a guaranty system via wired or wireless communication or data transmission; (4) obtaining or receiving, at the central processing system, guaranty data corresponding to a receiving party associated with the vehicle, the guaranty data obtained via the second communicative connection from the guaranty system via wired or wireless communication or data transmission; (5) generating, at the central processing system and based upon the telematics data and the guaranty data, terms of an obligation arrangement for which the receiving party is eligible; and/or (6) transmitting, via the one or more network interfaces, the generated obligation arrangement terms (or an indication thereof) to a device of the receiving party or the vehicle via wireless communication or data transmission over one or more radio links or communication channels. The method may include additional, less, or alternate actions, including those discussed elsewhere herein.

In another aspect, a computer-implemented method for collecting and analyzing telematics data may be provided. The method may include (1) establishing, via one or more network interfaces, a first communicative connection between a central processing system and a vehicle data system via wireless communication or data transmission over one or more radio links or communication channels; (2) obtaining or receiving, at the central processing system, telematics data indicative of operations of the vehicle via wireless communication or data transmission over one or more radio links or communication channels, wherein the telematics data includes an indication of miles driven or traveled by the vehicle and is obtained via the first communicative connection from the vehicle data system; (3) adjusting, via the central processing system, a monthly payment for a variable vehicle loan covering the vehicle based upon the telematics data and/or miles driven or traveled by the vehicle; (4) automatically withdrawing, via the central processing system, the adjusted monthly payment from a financial account associated with an owner of the vehicle or associated with the vehicle; and/or (5) transmitting, via the one or more network interfaces, the adjusted monthly payment (or an indication thereof) to a mobile device of the owner of the vehicle or vehicle data system via wireless communication or data transmission over one or more radio links or communication channels to facilitate adjusting a variable vehicle loan based upon vehicle depreciation. The method may include additional, less, or alternate actions, including those discussed elsewhere herein.

For instance, the method may include adjusting, via the central processing system, a variable interest rate for the variable vehicle loan based upon the telematics data and/or miles driven or traveled by the vehicle. Additionally or alternatively, the method may include adjusting, via the central processing system, a variable principal payment for the variable vehicle loan based upon the telematics data and/or miles driven or traveled by the vehicle to account for vehicle depreciation.

In another aspect, a computer-implemented method for collecting and analyzing telematics data may be provided. The method may include (1) establishing, via one or more network interfaces, a first communicative connection between a central processing system and a vehicle data system via wireless communication or data transmission over one or more radio links or communication channels; (2) obtaining or receiving, at the central processing system, telematics data indicative of operations of the vehicle via wireless communication or data transmission over one or more radio links or communication channels, wherein the telematics data is obtained via the first communicative connection from the vehicle data system and/or collected or generated by one or more vehicle-mounted or mobile-device sensors; (3) adjusting, via the central processing system, a variable vehicle loan covering the vehicle based upon the telematics data; (4) automatically withdrawing, via the central processing system, payment for the variable vehicle loan from a financial account associated with an owner of the vehicle or associated with the vehicle; and/or (5) transmitting, via the one or more network interfaces, information detailing the variable vehicle loan to a mobile device of the owner of the vehicle or the vehicle data system via wireless communication or data transmission over one or more radio links or communication channels to facilitate adjusting a variable vehicle loan based upon vehicle depreciation. The method may include additional, less, or alternate actions, including those discussed elsewhere herein.

For instance, the method may include adjusting, via the central processing system, a variable interest rate for the variable vehicle loan based upon the telematics data. The telematics data may include an indication of miles traveled by the vehicle, and the variable interest rate for the variable vehicle loan may be adjusted by the central processing system based upon the miles traveled by the vehicle. The telematics data may include an indication of number of trips driven or traveled by the vehicle, and the variable interest rate for the variable vehicle loan may be adjusted by the central processing system based upon the number of trips driven or traveled by the vehicle.

The telematics data may include an indication of an actual amount of money earned by a TNC driver using the vehicle (or the telematics data is used to estimate an estimated amount of money earned by the TNC driver using the vehicle), and the variable interest rate for the variable vehicle loan may be adjusted by the central processing system based upon the actual or estimated amount of money earned using the vehicle. The telematics data may include an indication of an actual amount of fuel used by a TNC driver using the vehicle (or the telematics data is used to estimate an estimated amount of fuel used by the TNC driver using the vehicle), and the variable interest rate for the variable vehicle loan may be adjusted by the central processing system based upon the actual or estimated amount of fuel used by the vehicle.

The method may include adjusting, via the central processing system, a variable principal payment for the variable vehicle loan based upon the telematics data to account for vehicle depreciation. The telematics data may include an indication of miles traveled by the vehicle, and the variable principal payment for the variable vehicle loan may be adjusted by the central processing system based upon the miles traveled by the vehicle. The telematics data may include an indication of number of trips driven or traveled by the vehicle, and the variable principal payment for the variable vehicle loan may be adjusted by the central processing system based upon the number of trips driven or traveled by the v

The telematics data may include an indication of an actual amount of money earned by a TNC driver using the vehicle (or the telematics data is used to estimate an estimated amount of money earned by the TNC driver using the vehicle), and the variable principal payment for the variable vehicle loan may be adjusted by the central processing system based upon the actual or estimated amount of money earned using the vehicle. The telematics data may include an indication of an actual amount of fuel used by a TNC driver using the vehicle (or the telematics data is used to estimate an estimated amount of fuel used by the TNC driver using the vehicle), and the variable principal payment for the variable vehicle loan may be adjusted by the central processing system based upon the actual or estimated amount of fuel used by the vehicle.

The method may include adjusting, via the central processing system, a usage-based insurance rate (such as pay by mile or time) for the vehicle and/or driver based upon the telematics data. The method may include estimating or determining a usage-based insurance premium or rate based upon the telematics data. The telematics data may include autonomous feature, system, or software usage, type, version, or operation.

In another aspect, a computer-implemented method for collecting and analyzing telematics data may be provided. The method may include (1) establishing, via one or more network interfaces, a first communicative connection between a central processing system and a vehicle data system via wireless communication or data transmission over one or more radio links or communication channels; (2) obtaining or receiving, at the central processing system, telematics data indicative of operations of the vehicle via wireless communication or data transmission over one or more radio links or communication channels, wherein the telematics data is obtained via the first communicative connection from the vehicle data system; (3) updating or estimating, via the central processing system, vehicle depreciation based upon the telematics data; (4) adjusting, via the central processing system, a variable vehicle loan covering the vehicle based upon the estimated vehicle depreciation; (5) automatically withdrawing, via the central processing system, payment for the variable vehicle loan from a financial account associated with an owner of the vehicle or associated with the vehicle; and/or (6) transmitting, via the one or more network interfaces, information detailing the adjusted variable vehicle loan and/or estimated vehicle depreciation to a mobile device of the owner of the vehicle or the vehicle data system via wireless communication or data transmission over one or more radio links or communication channels to facilitate adjusting a variable vehicle loan based upon vehicle depreciation. The method may include additional, less, or alternate actions, including those discussed elsewhere herein.

For instance, the method may include adjusting, via the central processing system, a variable interest rate and/or variable principal payment for the variable vehicle loan based upon the telematics data. The telematics data may include an indication of miles traveled by the vehicle, and the estimated vehicle depreciation for the variable vehicle loan may be adjusted by the central processing system based upon the miles traveled by the vehicle. The telematics data may include an indication of number of trips driven or traveled by the vehicle, and the adjusted or estimated vehicle depreciation may be adjusted or estimated by the central processing system based upon the number of trips driven or traveled by the vehicle.

The telematics data may include an indication of an actual amount of money earned by a TNC driver using the vehicle (or the telematics data may be used to estimate an estimated amount of money earned by the TNC driver using the vehicle), and the adjusted or estimated vehicle depreciation may be adjusted or estimated by the central processing system based upon the actual or estimated amount of money earned using the vehicle. The telematics data may include an indication of an actual amount of fuel used by a TNC driver using the vehicle (or the telematics data may be used to estimate an estimated amount of fuel used by the TNC driver using the vehicle), and the adjusted or estimated vehicle depreciation may be adjusted or estimated by the central processing system based upon the actual or estimated amount of fuel used by the vehicle. The method may include adjusting, via the central processing system, a usage-based insurance rate (such as pay by mile or time) for the vehicle and/or driver based upon the telematics data.

In another aspect, a computer system for collecting telematics data and/or adjusting a variable vehicle loan based upon the telematics data may be provided. The computer system may include one or more processors, sensors, and/or transceivers configured to: (1) establish, via one or more network interfaces, a first communicative connection between a central processing system and a vehicle data system via wireless communication or data transmission over one or more radio links or communication channels; (2) obtain or receive, at the central processing system, telematics data indicative of operations of the vehicle via wireless communication or data transmission over one or more radio links or communication channels, wherein the telematics data includes an indication of miles driven or traveled by the vehicle and is obtained via the first communicative connection from the vehicle data system; (3) establish, via the one or more network interfaces, a second communicative connection between the central processing system and a guaranty system via wired or wireless communication or data transmission; (4) obtain or receive, at the central processing system, guaranty data corresponding to a receiving party associated with the vehicle, the guaranty data obtained via the second communicative connection from the guaranty system via wired or wireless communication or data transmission; (5) generate, at the central processing system and based upon the telematics data and the guaranty data, terms of an obligation arrangement for which the receiving party is eligible; and/or (6) transmit, via the one or more network interfaces, the generated obligation arrangement terms to a device of the receiving party or the vehicle via wireless communication or data transmission over one or more radio links or communication channels. The computer system may include additional, less, or alternate functionality, including that discussed elsewhere herein.

In another aspect, a computer system for collecting telematics data and/or adjusting a variable vehicle loan based upon the telematics data may be provided. The computer system may include one or more processors, sensors, and/or transceivers configured to: (1) establish, via one or more network interfaces, a first communicative connection between a central processing system and a vehicle data system via wireless communication or data transmission over one or more radio links or communication channels; (2) obtain or receive, at or via the central processing system, telematics data indicative of operations of the vehicle via wireless communication or data transmission over one or more radio links or communication channels, wherein the telematics data includes an indication of miles driven or traveled by the vehicle and is obtained via the first communicative connection from the vehicle data system; (3) adjust, via the central processing system, a monthly payment for a variable vehicle loan covering the vehicle based upon the telematics data and/or miles driven or traveled by the vehicle; (4) automatically withdraw, via the central processing system, the adjusted monthly payment from a financial account associated with an owner of the vehicle or associated with the vehicle; and/or (5) transmit, via the one or more network interfaces, the adjusted monthly payment to a mobile device of the owner of the vehicle or vehicle data system via wireless communication or data transmission over one or more radio links or communication channels to facilitate adjusting a variable vehicle loan based upon vehicle depreciation. The system may include additional, less, or alternate functionality, including that discussed elsewhere herein.

For instance, the system may be configured to adjust, via the central processing system, a variable interest rate for the variable vehicle loan based upon the telematics data and/or miles driven or traveled by the vehicle. Additionally or alternatively, the system may be configured to adjust, via the central processing system, a variable principal payment for the variable vehicle loan based upon the telematics data and/or miles driven or traveled by the vehicle to account for vehicle depreciation.

In another aspect, a computer system for collecting telematics data and/or adjusting a variable vehicle loan may be provided. The system may include one or more processors, sensors, and/or transceivers configured to: (1) establish, via one or more network interfaces, a first communicative connection between a central processing system and a vehicle data system via wireless communication or data transmission over one or more radio links or communication channels; (2) obtain or receive, at the central processing system, telematics data indicative of operations of the vehicle via wireless communication or data transmission over one or more radio links or communication channels, wherein the telematics data is obtained via the first communicative connection from the vehicle data system; (3) adjust, via the central processing system, a variable vehicle loan covering the vehicle based upon the telematics data; (4) automatically withdraw, via the central processing system, payment for the variable vehicle loan from a financial account associated with an owner of the vehicle or associated with the vehicle; and/or (5) transmit, via the one or more network interfaces, information detailing the variable vehicle loan to a mobile device of the owner of the vehicle or the vehicle data system via wireless communication or data transmission over one or more radio links or communication channels to facilitate adjusting a variable vehicle loan based upon vehicle depreciation. The system may include additional, less, or alternate functionality, including that discussed elsewhere herein.

In another aspect, a computer system for collecting telematics data and/or adjusting a variable vehicle loan based upon the telematics data may be provided. The system may include one or more processors, sensors, and/or transceivers configured to: (1) establish, via one or more network interfaces, a first communicative connection between a central processing system and a vehicle data system via wireless communication or data transmission over one or more radio links or communication channels; (2) obtain or receive, at the central processing system, telematics data indicative of operations of the vehicle via wireless communication or data transmission over one or more radio links or communication channels, wherein the telematics data is obtained via the first communicative connection from the vehicle data system; (3) update or estimate, via the central processing system, vehicle depreciation based upon the telematics data; (4) adjust, via the central processing system, a variable vehicle loan covering the vehicle based upon the estimated vehicle depreciation; (5) automatically withdraw, via the central processing system, payment for the variable vehicle loan from a financial account associated with an owner of the vehicle or associated with the vehicle; and/or (6) transmit, via the one or more network interfaces, information detailing the adjusted variable vehicle loan and/or estimated vehicle depreciation to a mobile device of the owner of the vehicle or the vehicle data system via wireless communication or data transmission over one or more radio links or communication channels to facilitate adjusting a variable vehicle loan based upon vehicle depreciation. The system may include additional, less, or alternate functionality, including that discussed elsewhere herein.

In another aspect, a computer-implemented method for collecting and/or analyzing telematics data may be provided. The method may include (1) receiving, via one or more processors and/or associated transceivers, telematics data indicative of operation of a vehicle via wireless communication or data transmission over one or more radio links or communication channels from a vehicle computer system or customer mobile device, wherein the telematics data is generated by one or more vehicle-mounted or mobile device-mounted sensors; (2) updating or estimating, via the one or more processors, vehicle depreciation based upon the telematics data; (3) adjusting, via the one or more processors, a variable vehicle loan covering the vehicle based upon the estimated vehicle depreciation (and/or telematics data); (4) automatically withdrawing, via the one or more processors, payment for the variable vehicle loan from a financial account associated with an owner of the vehicle or associated with the vehicle; and/or (5) transmitting, via the one or more processors and/or associated transceivers, information detailing the adjusted variable vehicle loan and/or estimated vehicle depreciation to a mobile device of the owner of the vehicle or the vehicle computer system via wireless communication or data transmission over one or more radio links or communication channels to facilitate adjusting a variable vehicle loan based upon vehicle depreciation. The method may include additional, less, or alternate actions, including those discussed elsewhere herein.

In another aspect, a computer-implemented method for collecting and/or analyzing telematics data may be provided. The method may include (1) receiving, via one or more processors and/or associated transceivers, telematics data indicative of operation of a vehicle via wireless communication or data transmission over one or more radio links or communication channels from a vehicle computer system or customer mobile device, wherein the telematics data is generated by one or more vehicle-mounted or mobile device-mounted sensors; (2) updating or adjusting, via the one or more processors, a variable vehicle loan covering the vehicle based upon the telematics data; (3) automatically withdrawing, via the one or more processors, a periodic, monthly, or other payment for the variable vehicle loan from a financial account associated with an owner of the vehicle or associated with the vehicle; and/or (4) transmitting, via the one or more processors and/or associated transceivers, information detailing the adjusted variable vehicle loan to a mobile device of the owner of the vehicle or the vehicle computer system via wireless communication or data transmission over one or more radio links or communication channels to facilitate adjusting a variable vehicle loan based upon vehicle depreciation. The method may include additional, less, or alternate actions, including those discussed elsewhere herein.

In another aspect, a computer system for collecting and analyzing telematics data and/or adjusting variable vehicle loans based upon the telematics data may be provided. The system may include one or more processors, sensors, and/or transceivers configured to: (1) receive, via one or more processors and/or associated transceivers, telematics data indicative of operation of a vehicle via wireless communication or data transmission over one or more radio links or communication channels from a vehicle computer system or customer mobile device, wherein the telematics data is generated by one or more vehicle-mounted or mobile device-mounted sensors; (2) update or estimate, via the one or more processors, vehicle depreciation based upon the telematics data; (3) adjust, via the one or more processors, a variable vehicle loan covering the vehicle based upon the estimated vehicle depreciation (and/or telematics data); (4) automatically withdraw, via the one or more processors, payment for the variable vehicle loan from a financial account associated with an owner of the vehicle or associated with the vehicle; and/or (5) transmit, via the one or more processors and/or associated transceivers, information detailing the adjusted variable vehicle loan and/or estimated vehicle depreciation to a mobile device of the owner of the vehicle or the vehicle computer system via wireless communication or data transmission over one or more radio links or communication channels to facilitate adjusting a variable vehicle loan based upon vehicle depreciation. The system may include additional, less, or alternate functionality, including that discussed elsewhere herein.

In another aspect, a computer system for collecting and analyzing telematics data may be provided. The system may include one or more processors, sensors, and/or transceivers configured to: (1) receive, via one or more processors and/or associated transceivers, telematics data indicative of operation of a vehicle via wireless communication or data transmission over one or more radio links or communication channels from a vehicle computer system or customer mobile device, wherein the telematics data is generated by one or more vehicle-mounted or mobile device-mounted sensors; (2) update or adjust, via the one or more processors, a variable vehicle loan covering the vehicle based upon the telematics data; (3) automatically withdraw, via the one or more processors, a periodic, monthly, or other payment for the variable vehicle loan from a financial account associated with an owner of the vehicle or associated with the vehicle; and/or (4) transmit, via the one or more processors and/or associated transceivers, information detailing the adjusted variable vehicle loan to a mobile device of the owner of the vehicle or the vehicle computer system via wireless communication or data transmission over one or more radio links or communication channels to facilitate adjusting a variable vehicle loan based upon vehicle depreciation. The system may include additional, less, or alternate functionality, including that discussed elsewhere herein.

For instance, the system may be configured to adjust, via the one or more processors, a variable interest rate and/or variable principal payment for the variable vehicle loan based upon the telematics data. The telematics data may include an indication of miles traveled by the vehicle, and the variable vehicle loan may be adjusted by the one or more processors based upon the miles traveled by the vehicle. The telematics data may include an indication of number of trips driven or traveled by the vehicle, and the variable vehicle loan may be adjusted or estimated by the one or more processors based upon the number of trips driven or traveled by the vehicle.

The telematics data may include an indication of an actual amount of money earned by a TNC driver using the vehicle (or the telematics data is used to estimate an estimated amount of money earned by the TNC driver using the vehicle), and the variable vehicle loan may be adjusted by the one or more processors based upon the actual or estimated amount of money earned using the vehicle. Additionally or alternatively, the telematics data may include an indication of an actual amount of fuel used by a TNC driver using the vehicle (or the telematics data is used to estimate an estimated amount of fuel used by the TNC driver using the vehicle), and the variable vehicle loan may be adjusted or estimated by the one or more processors based upon the actual or estimated amount of fuel used by the vehicle.

The system may be configured to adjust or determine, via the one or more processors, a usage-based insurance rate (such as pay by mile or time) for the vehicle and/or driver based upon the telematics data. The telematics data may include speed, acceleration, deceleration, braking, mileage, and/or cornering information associated with vehicle operation.

The system may be configured to estimate or determine vehicle mileage, number of vehicle trips, money earned using the vehicle, and/or estimated fuel costs, via the one or more processors, based upon the telematics data received.

The telematics data may include an indication of actual or estimated (i) vehicle mileage, (ii) number of vehicle trips taken, (iii) money earned using the vehicle by a TNC operator, and/or (iv) fuel costs.

The telematics data may include an indication of autonomous vehicle feature or system usage, and the vehicle may be an autonomous or semi-autonomous vehicle. The system may be configured to update or adjust a variable rate credit card for a TNC driver based upon the telematics data.

In another aspect, a computer-implemented method for generating an insurance discount (e.g., a vehicle insurance discount) may be provided. The method may include (1) establishing, via one or more network interfaces, a first communicative connection between a central processing system and a vehicle data system of a vehicle; (2) obtaining, at the central processing system, data indicative of operations of the vehicle, wherein the vehicle operations data includes one or more vehicular telemetry metrics and is obtained via the first communicative connection from the vehicle data system; (3) establishing, via the one or more network interfaces, a second communicative connection between the central processing system and an insurance system; (4) obtaining, at the central processing system, insurance data corresponding to a receiving party associated with the vehicle, the insurance data obtained via the second communicative connection from the insurance system; (5) generating, at the central processing system and based upon the vehicle operations data and the insurance data, an insurance discount for which the receiving party is eligible; and/or (6) transmitting, via the one or more network interfaces, the generated insurance discount (or an indication thereof) to a device of the receiving party. The method may include additional, less, or alternate actions, including those discussed elsewhere herein.

In another aspect, a system configured to generate an insurance discount (e.g., a vehicle insurance discount) may be provided. The system may include (1) one or more processors; and (2) one or more memories storing computer-executable instructions that, when executed via the one or more processors, cause the system to (a) establish, via one or more network interfaces, a first communicative connection between a central processing system and a vehicle data system of a vehicle; (b) obtain, at the central processing system, data indicative of operations of the vehicle, wherein the vehicle operations data includes one or more vehicular telemetry metrics and is obtained via the first communicative connection from the vehicle data system; (c) establish, via the one or more network interfaces, a second communicative connection between the central processing system and an insurance system; (d) obtain, at the central processing system, insurance data corresponding to a receiving party associated with the vehicle, the insurance data obtained via the second communicative connection from the insurance system; (e) generate, at the central processing system and based upon the vehicle operations data and the insurance data, an insurance discount for which the receiving party is eligible; and/or (f) transmit, via the one or more network interfaces, the generated insurance discount (or an indication thereof) to a device of the receiving party. The system may be configured to perform additional, less, or alternate actions, including those discussed herein.

In another aspect, a computer-implemented method for generating an insurance quote (e.g., a vehicle insurance quote) or insurance policy may be provided. The method may include (1) establishing, via one or more network interfaces, a first communicative connection between a central processing system and a vehicle data system of a vehicle; (2) obtaining, at the central processing system, data indicative of operations of the vehicle, wherein the vehicle operations data includes one or more vehicular telemetry metrics and is obtained via the first communicative connection from the vehicle data system; (3) establishing, via the one or more network interfaces, a second communicative connection between the central processing system and an insurance system; (4) obtaining, at the central processing system, insurance data corresponding to a receiving party associated with the vehicle, the insurance data obtained via the second communicative connection from the insurance system; (5) generating, at the central processing system and based upon the vehicle operations data and the insurance data, one or more terms of an insurance policy for which the receiving party is; and/or (6) transmitting, via the one or more network interfaces, the generated one or more terms (or an indication thereof) to a device of the receiving party. The method may include additional, less, or alternate actions, including those discussed elsewhere herein.

In another aspect, a system configured to generate an insurance quote (e.g., a vehicle insurance discount) or insurance policy may be provided. The system may include (1) one or more processors; and (2) one or more memories storing computer-executable instructions that, when executed via the one or more processors, cause the system to (a) establish, via one or more network interfaces, a first communicative connection between a central processing system and a vehicle data system of a vehicle; (b) obtain, at the central processing system, data indicative of operations of the vehicle, wherein the vehicle operations data includes one or more vehicular telemetry metrics and is obtained via the first communicative connection from the vehicle data system; (c) establish, via the one or more network interfaces, a second communicative connection between the central processing system and an insurance system; (d) obtain, at the central processing system, insurance data corresponding to a receiving party associated with the vehicle, the insurance data obtained via the second communicative connection from the insurance system; (e) generate, at the central processing system and based upon the vehicle operations data and the insurance data, one or more terms of an insurance policy or quote for which the receiving party is eligible; and/or (f) transmit, via the one or more network interfaces, the generated one or more terms (or an indication thereof) to a device of the receiving party. The system may be configured to perform additional, less, or alternate actions, including those discussed herein.

In another aspect, a computer-implemented method for generating or offering a credit card (e.g., a variable-rate credit card) may be provided. The method may include (1) establishing, via one or more network interfaces, a first communicative connection between a central processing system and a vehicle data system of a vehicle; (2) obtaining, at the central processing system, data indicative of operations of the vehicle, wherein the vehicle operations data includes one or more vehicular telemetry metrics and is obtained via the first communicative connection from the vehicle data system; (3) establishing, via the one or more network interfaces, a second communicative connection between the central processing system and a credit system; (4) obtaining, at the central processing system, credit data corresponding to a receiving party associated with the vehicle, the credit data obtained via the second communicative connection from the credit system; (5) generating, at the central processing system and based upon the vehicle operations data and the credit data, one or more terms of a credit card for which the receiving party is eligible; and/or (6) transmitting, via the one or more network interfaces, the generated one or more terms (or an indication thereof) to a device of the receiving party. The method may include additional, less, or alternate actions, including those discussed elsewhere herein.

In another aspect, a system configured to generate or offer a credit card (e.g., a variable-rate credit card) may be provided. The system may include (1) one or more processors; and (2) one or more memories storing computer-executable instructions that, when executed via the one or more processors, cause the system to (a) establish, via one or more network interfaces, a first communicative connection between a central processing system and a vehicle data system of a vehicle; (b) obtain, at the central processing system, data indicative of operations of the vehicle, wherein the vehicle operations data includes one or more vehicular telemetry metrics and is obtained via the first communicative connection from the vehicle data system; (c) establish, via the one or more network interfaces, a second communicative connection between the central processing system and a credit system; (d) obtain, at the central processing system, credit data corresponding to a receiving party associated with the vehicle, the credit data obtained via the second communicative connection from the credit system; (e) generate, at the central processing system and based upon the vehicle operations data and the credit data, one or more terms of an credit card for which the receiving party is eligible; and/or (f) transmit, via the one or more network interfaces, the generated one or more terms (or an indication thereof) to a device of the receiving party. The system may be configured to perform additional, less, or alternate actions, including those discussed herein.

### OTHER MATTERS

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for system and a method for assigning mobile device data to a vehicle through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

The patent claims at the end of this patent application are not intended to be construed under 35 U.S.C. § 112(f), unless traditional means-plus-function language, such as “means for” or “step for” language, is explicitly recited in the claim(s). The systems and methods described herein are directed to an improvement in computer functionality, and improve the functioning of conventional computers.

1. A computer-implemented method comprising:
obtaining, via one or more processors, telematics data indicative of operation of a vehicle, wherein the telematics data includes data generated by one or more vehicle-mounted sensors, the telematics data being obtained by the one or more processors from the one or more vehicle-mounted sensors upon sampling of the telematics data by the one or more vehicle-mounted sensors during operation of the vehicle;
determining, via the one or more processors, based at least upon the telematics data generated by the one or more vehicle-mounted sensors, one or more autonomous features present in the vehicle and an extent of usage of the one or more autonomous features during the operation of the vehicle;
determining or adjusting, via the one or more processors, based at least upon the presence and extent of usage of the one or more autonomous features, an estimated depreciation of the vehicle;
adjusting, via the one or more processors, one or more terms of a variable vehicle loan covering the vehicle, based upon the telematics data and the estimated depreciation;
automatically withdrawing, via the one or more processors, a payment for the variable vehicle loan from a financial account associated with an owner of the vehicle or associated with the vehicle; and
transmitting, via the one or more processors, information detailing the adjusted variable vehicle loan to a mobile device of the owner of the vehicle.

2. The computer-implemented method of claim 1, wherein the adjustment to the one or more terms of the variable vehicle loan includes an adjustment to a variable interest rate or a variable principal payment for the variable vehicle loan based upon the telematics data.

3. The computer-implemented method of claim 1, wherein the telematics data includes an indication of distance driven or otherwise traveled by the vehicle, and wherein the adjustment to the one or more terms of the variable vehicle loan is based upon the distance driven or otherwise traveled.

4. The computer-implemented method of claim 1, wherein the telematics data includes an indication of a number of trips driven or otherwise traveled by the vehicle, and wherein the adjustment to the one or more terms of the variable vehicle loan is based upon the number of trips driven or otherwise traveled.

5. The computer-implemented method of claim 1, wherein the telematics data includes an indication of an actual or estimated amount of money earned by a transportation network company driver using the vehicle, and wherein the adjustment to the one or more terms of the variable vehicle loan is based upon the actual or estimated amount of money earned.

6. The computer-implemented method of claim 1, wherein the telematics data includes an indication of an actual or estimated amount of fuel used by a transportation network company driver using the vehicle, and wherein the adjustment to the one or more terms of the variable vehicle loan is based upon the actual or estimated amount of fuel used.

7. The computer-implemented method of claim 1, further comprising adjusting or determining, via the one or more processors, a usage-based insurance rate for the vehicle or driver based upon the telematics data.

8. The computer-implemented method of claim 1, wherein the telematics data includes at least one of speed, acceleration, deceleration, braking, mileage, or cornering information associated with vehicle operation.

9. The computer-implemented method of claim 1, further comprising estimating, via the one or more processors, a depreciation of the vehicle based upon the telematics data.

10. The computer-implemented method of claim 9, further comprising transmitting, via the one or more processors, information detailing the vehicle depreciation to the mobile device of the owner of the vehicle.

11. A computer system comprising:
a communicative connection to a vehicle data system of a vehicle;
one or more processors; and
one or more memories storing non-transitory computer-executable instructions that, when executed via the one or more processors, cause the system to:
obtain, via one or more processors, telematics data indicative of operation of a vehicle, wherein the telematics data includes data generated by one or more vehicle-mounted sensors, the telematics data being obtained by the one or more processors from the one or more vehicle-mounted sensors via the communicative connection upon sampling of the telematics data by the one or more vehicle-mounted sensors during operation of the vehicle;
determine, via the one or more processors, based at least upon the telematics data, one or more autonomous features present in the vehicle and an extent of usage of the one or more autonomous features of the vehicle;
determine or adjust, via the one or more processors, based at least upon the presence and extent of usage of the one or more autonomous features, an estimated depreciation of the vehicle;
adjust, via the one or more processors, one or more terms of a variable vehicle loan covering the vehicle, based upon the telematics data and the estimated depreciation;
automatically withdraw, via the one or more processors, a payment for the variable vehicle loan from a financial account associated with an owner of the vehicle or associated with the vehicle; and
transmit, via the one or more processors, information detailing the adjusted variable vehicle loan to a mobile device of the owner of the vehicle.

12. The system of claim 11, wherein the adjustment to the one or more terms of the variable vehicle loan includes an adjustment to a variable interest rate or variable principal payment for the variable vehicle loan based upon the telematics data.

13. The system of claim 11, wherein the telematics data includes an indication of distance driven or otherwise traveled by the vehicle, and wherein the adjustment to the one or more terms of the variable vehicle loan is based upon the distance driven or otherwise traveled.

14. The system of claim 11, wherein the telematics data includes at least one of speed, acceleration, deceleration, braking, mileage, or cornering information associated with vehicle operation.

15. The system of claim 11, wherein the computer-executable instructions, when executed via the one or more processors, further cause the system to estimate or determine at least one of a vehicle mileage, a number of vehicle trips, an amount of money earned using the vehicle, or an estimated fuel cost based upon the telematics data received.

16. The system of claim 11, wherein the telematics data includes an indication at least one of an actual or estimated (i) vehicle mileage, (ii) number of vehicle trips taken, (iii) money earned using the vehicle by a transportation network company operator, or (iv) fuel cost.

17. (canceled)

18. The system of claim 11, wherein the computer-executable instructions, when executed via the one or more processors, further cause the system to update or adjust one or more terms of a variable rate credit card for a transportation network company driver based upon the telematics data.

19. The system of claim 11, wherein the computer-executable instructions, when executed via the one or more processors, further cause the system to estimate, via the one or more processors, a depreciation of the vehicle based upon the telematics data.

20. The system of claim 19, wherein the computer-executable instructions, when executed via the one or more processors, further cause the system to transmit, via the one or more processors, information detailing the vehicle depreciation to the mobile device of the owner of the vehicle.
